(19) United States
(12) Patent Application Publication
(10) Pub. No.: US 2012/0262344 A1
(43) Pub. Date: Oct. 18, 2012

(54) PORTABLE ELECTRICAL DEVICE AND ITS MANUFACTURING METHOD

(75) Inventors: Ming-Hsueh Tsai, New Taipei City (TW); Ying-Chih Wang, Taoyuan Shien (TW); Chien-Chiang Huang, Taoyuan County (TW); Hsien-Ming Wu, New Taipei City (TW)

(73) Assignee: Quanta Computer Inc., Taoyuan Shien (TW)

(21) Appl. No.: 13/241,319

(22) Filed: Sep. 23, 2011

(30) Foreign Application Priority Data
Apr. 13, 2011 (TW) 100112850

(51) Int. Cl. H01Q 1/24; B29C 45/14

(52) U.S. Cl. 343/702; 264/272.14

(57) ABSTRACT

A portable electrical device includes a chassis, a plurality of conductive bodies, a wireless RF module and a cable. The chassis includes a casing layer and a radiator layer stacked with each other. The conductive bodies are embedded inside the casing layer, in which one end of each conductive body exposes outwards one surface of the plastic casing layer, and the other end of each conductive body exposes outwards the other surface of the casing layer and electrically conducts the radiator layer. The cable is electrically conducted with the conductive bodies and the wireless RF module.

### RELATED APPLICATIONS

This application claims priority to Taiwanese Application Serial Number 100112850, filed Apr. 13, 2011, which is herein incorporated by reference.

### BACKGROUND

1. Technical Field

The present invention relates to a portable electrical device, more particular to a portable electrical device having a radiating antenna.

2. Description of Related Art

Nowadays, a portable electrical device, such as a mobile phone or a notebook computer, has already been involved into our daily life, and the portable electrical device has been developed to provide not only functions of Internet wireless connection, but also information process, furthermore, more functions such as PDA and GPS etc., are also integrated into the portable electrical devices.

An antenna is an essential element for Internet wireless connection or GPS connection in the portable electrical device. Normally, a traditional antenna structure is in the form of a metal wire stand, for aesthetic purposes, the metal wire stand of the antenna structure can be configured inside an inner space of a metal shell of the portable electrical device, and for example, located to neighbor the upper edge of a display module thereof.

However, since the antenna is configured inside the metal shell of the portable electrical device, the function of the antenna might be shielded by the metal shell of the portable electrical device, thus, the radiation pattern generated by the antenna might be interfered by the metal shell of the portable electrical device, therefore, the effectiveness of transmission/receiving of signals will be reduced significantly.

Furthermore, since the dimension of the antenna structure formed as a metal wire stand or a PCB antenna is provided with a certain thickness, when the antenna structure is configured inside the metal shell of the portable electrical device, it might be restricted for practicing in miniaturization design of the metal shell of the portable electrical device.

For example, the portable electrical device comprises an upper unit, a lower unit and a pivot unit. The pivot unit pivotally interconnects the upper unit and the lower unit. The upper unit is provided with a display module, an outer chassis and an inner chassis in which the outer chassis and the inner chassis are opposite with each other, and the display module is sandwiched between the outer chassis and the inner chassis. Also, the outer chassis is substantially formed as a rectangular which is provided with two opposite long lateral sides and two opposite short lateral sides.

For achieving the outer edge of the outer chassis in thin style, the two short lateral sides of the outer chassis and one of the long lateral sides of the outer chassis farest away from the pivot unit are respectively inclined gradually towards the inner chassis.

However, since the design mentioned above causes the inner space of the metal shell thereof neighboring the upper edge of the display module thereof being shrunk, the metal wire stand of the antenna structure is too large to configure in the inner space of the metal shell thereof neighboring the upper edge of the display module thereof.

Thus, in order to solve the problem, the developing personnel in the related fields cost a lot time and manpower in the antenna design.

### SUMMARY

The present invention is to disclose a portable electrical device which is capable of transmitting and receiving antenna signals externally.

The present invention is to disclose a portable electrical device which is downsized an antenna configured inside the portable electrical device so as to increase utility room in a chassis of the portable electrical device.

One mode of the present invention is to provide a portable electrical device. The portable electrical device comprises a chassis, a plurality of conductive bodies, a wireless RF module and a cable. The chassis comprises a case layer and a radiator layer. The case layer is provided with an inner surface and an outer surface opposite with each other. The radiator layer is stacked on the outer surface of the case layer. The conductive bodies are respectively embedded inside the case layer, in which each of the conductive bodies has at least one first end and a second end positioned oppositely with each other, each first end of each conductive body is exposed outwards the inner surface of the case layer, and each second end of each conductive body is exposed outwards the outer surface of the case layer and electrically conducted with the radiator layer. The cable is electrically interconnected the conductive bodies and the wireless RF module.

Another mode of the present invention is to provide a manufacturing method of a portable electrical device. The manufacturing method of the portable electrical device comprises one step of placing a multi-layer film and a plurality of conductive bodies into a cavity of an injection mold equipment in which the multi-layer film comprises a radiator layer, an ink layer and a protective layer in sequence; and another step of filling a molten plastic material into the cavity of the injection mold equipment so that the molten plastic material is formed as a case in which the multi-layer film is attached on an outer surface of the case, the conductive bodies are embedded into the case in which one end of each conductive body is exposed outwards the outer surface of the case and is electrically conducted with the radiator layer, and another end of each conductive body is exposed outwards an inner surface of the case.

To sum up, by setting a radiator layer on an outer surface of the case, rather than to dispose another lager antenna inside the chassis of the portable electrical device so as to save utility room in the chassis. Furthermore, by implementing an insert molding technology in the present invention, the conductive bodies are embedded to penetrate through the chassis, and the conductive bodies can interconnect the radiator layer and the wireless RF module which are positioned oppositely on the chassis so that a complicated wiring process used for interconnecting the radiator layer and the wireless RF module can be eliminated.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view illustrating a portable electrical device according to one embodiment of the present invention.

FIG. 2 is a schematic view illustrating a first chassis in FIG. 1 observed along a direction D1.

FIG. 3A is a sectional view of the first chassis according to one variation.

FIG. 3B is a sectional view of the first chassis according to another variation.

FIG. 3C is a sectional view of the first chassis according to the other variation.

FIG. 4 is a partial schematic view illustrating the first chassis in FIG. 1 observed along a direction D2.

FIG. 5 is a sectional view of FIG. 4 along with line 5-5.

FIG. 6 is a schematic view illustrating the position relations of the embedded conductive bodies and the antenna pattern on the first chassis.

FIG. 7 is a schematic view illustrating the first chassis of the portable electrical device observed along the direction D2 through the second chassis according to another embodiment of the present invention.

FIG. 8 is a flowchart of a method of manufacturing a portable electrical device according to one embodiment of the present invention.

FIG. 9 is an operation schematic view of an injection mold equipment when processing Step 801 in FIG. 8.

FIG. 10 is an operation schematic view of the injection mold equipment when processing Step 802 in FIG. 8.

FIG. 11 is a partial schematic view of the first chassis when processing Step 802 in FIG. 8.

FIG. 12 is a partial schematic view of the first chassis when processing Step 803 in FIG. 8.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

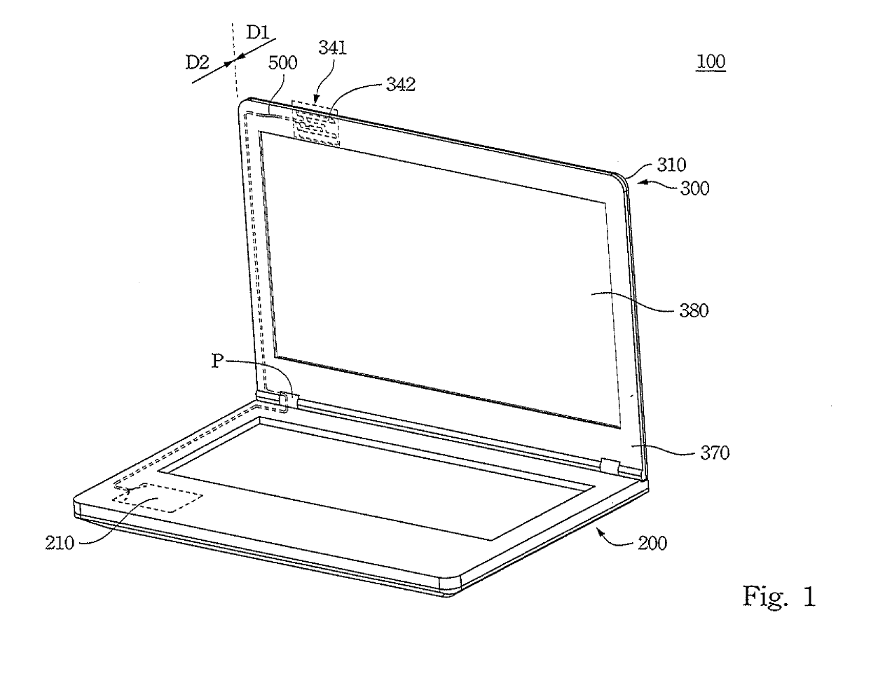

Refer to FIG. 1 in which FIG. 1 is a perspective view illustrating a portable electrical device 100 according to one embodiment of the present invention.

In the embodiment, the portable electrical device 100, for example, a notebook computer, includes a base unit 200, a display unit 300 and a pivot unit P. The pivot unit P pivotally interconnects the base unit 200 and the display unit 300 so that the display unit 300 can be rotated to cover the base unit 200 or rotated to leave the base unit 200.

The display unit 300 includes a first chassis 310, a second chassis 370 and a display panel 380. The first chassis 310 and the second chassis 370 are assembled together so as to sandwich the display panel 380 between the first chassis 310 and the second chassis 370, and to expose the display panel 380 from the second chassis 370. Furthermore, the base unit 200 is provided with a wireless RF (Radio Frequency) module 210 therein. The first chassis 310 is substantially formed as a rectangular which is provided with two opposite long lateral sides 311 and two opposite short lateral sides 312.

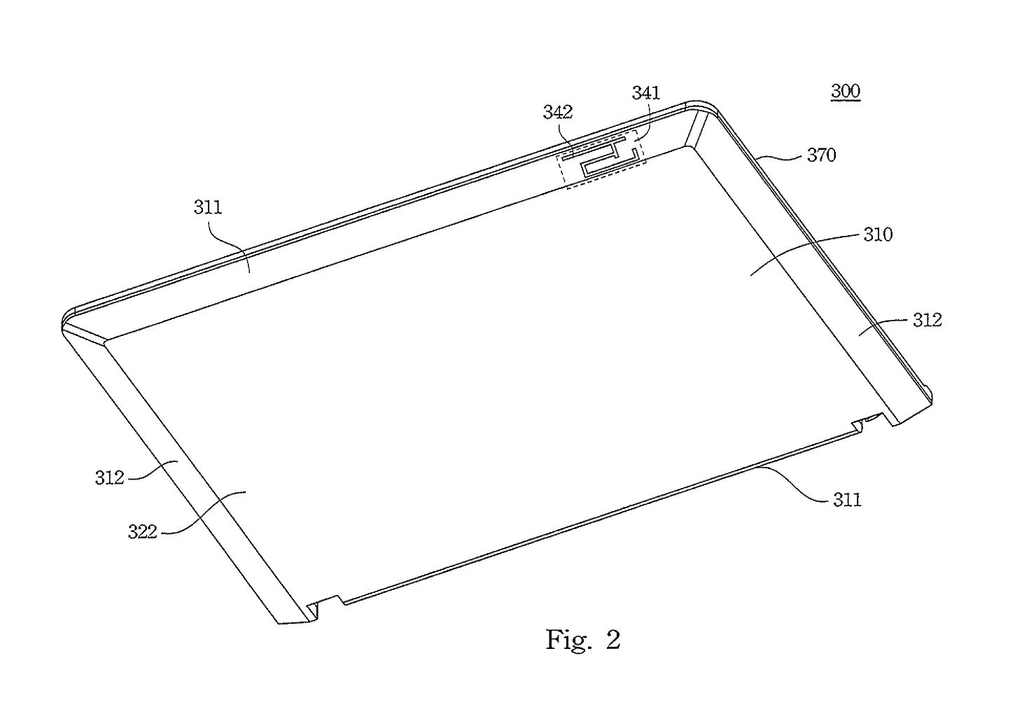

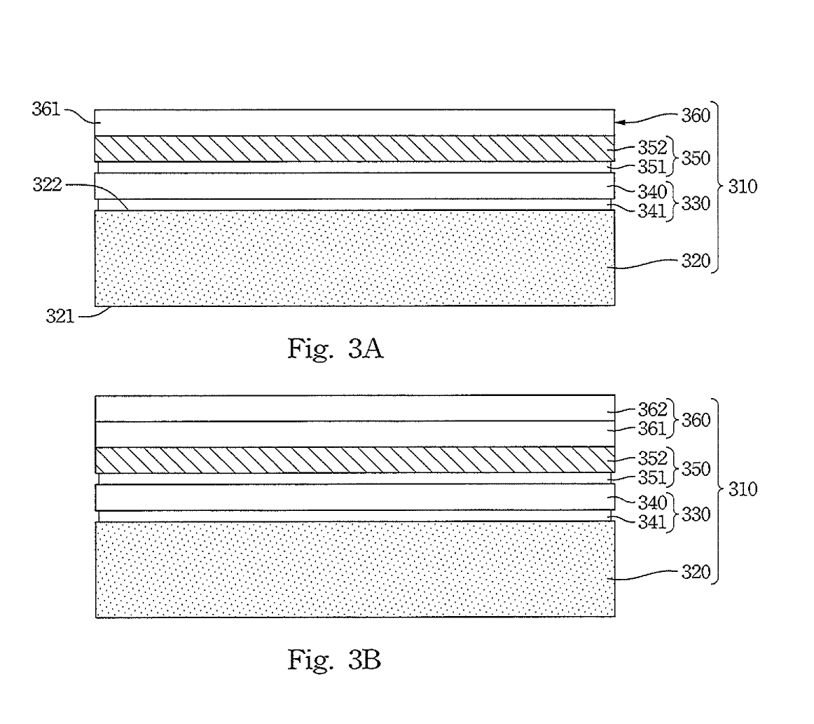

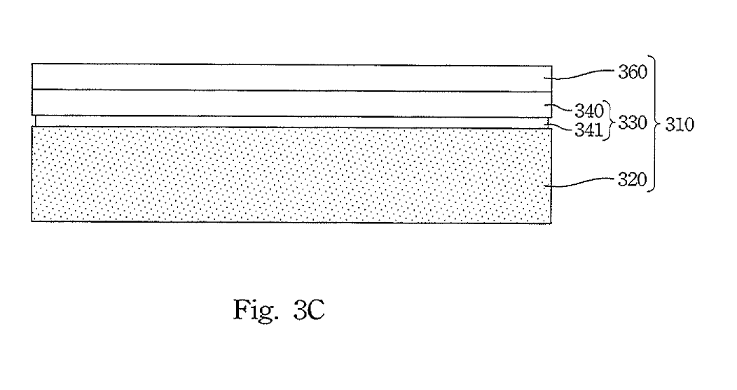

Refer to FIG. 2 and FIG. 3A in which FIG. 2 is a schematic view illustrating a first chassis 310 in FIG. 1 observed along a direction D1, FIG. 3A is a sectional view of the first chassis 310 according to one variation.

The first chassis 310 includes a case layer 320, a radiator layer 330, an ink layer 350 and a protective layer 360 in which the case layer 320, the radiator layer 330, the ink layer 350 and the protective layer 360 are stacked together in sequence. The case layer 320 is provided with an outer surface 322 and an inner surface 321 positioned oppositely with each other in which the inner surface 321 of the case layer 320 is closer to the second chassis 370 than the outer surface 322 of the case layer 320, and the radiator layer 330 covers the outer surface 322 of the case layer 320. The protective layer 360 covers one side of the radiator layer 330 opposite to the case layer 320, and the ink layer 350 is sandwiched between the radiator layer 330 and the protective layer 360.

In the embodiment, the radiator layer 330 is fixed on the case layer 320 by adhesive which is not shown in the figures. The radiator layer 330 includes a thin film layer 340 and one or more antenna patterns 341. The antenna patterns 341 are composed by metal wires 342, and are all sandwiched between the thin film layer 340 and the outer surface 322 of the case layer 320. The metal wires 342 can be made by printing electrically conductive metal powders, e.g. copper powder or silver powder, on the thin film layer 340. The ink layer 350 comprises one or more designed ink patterns, and is attached on a base membrane 352 (e.g. PET or PC).

Refer to FIG. 3B, in one variation of the embodiment, when the first chassis 310 is formed by In-Mold Forming (IMF) technology, the protective layer 360 includes a hard coated layer 361 and an exterior film layer 362. The hard coated layer 361 covers one side of the ink layer 350 opposite against the case layer 320, and sandwiched between the exterior film layer 362 and the ink layer 350. The exterior film layer 362 covers one side of the ink layer 350 opposite against the case layer 320.

Refer to FIG. 3A in which FIG. 3A is a sectional view of the first chassis 310 according to another variation. In another variation of the embodiment, when the first chassis 310 is formed by In-Mold Roller (IMR) technology, the protective layer 360 is merely a hard coated layer 361. The hard coated layer 361 covers one side of the ink layer 350 opposite against the case layer 320.

Refer to FIG. 3C in which FIG. 3C is a sectional view of the first chassis according to the other variation. In other variation of the embodiment, after choosing suitable ink powders and patterns properly, the ink layer mentioned above can be integrated into the radiator layer 330.

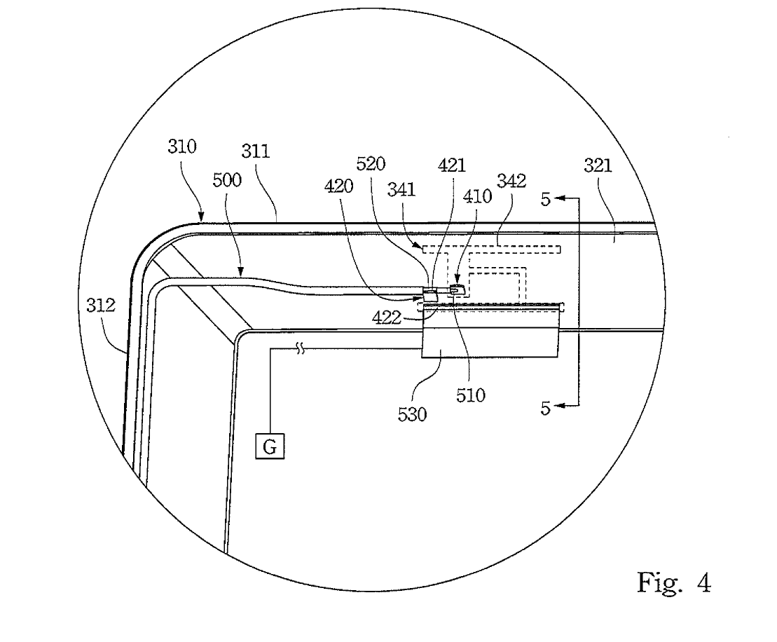

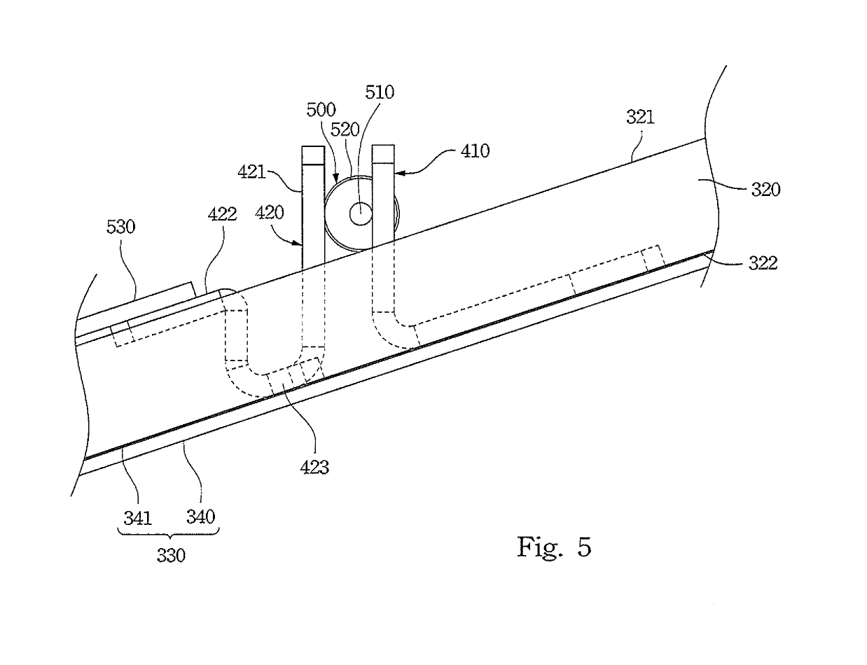

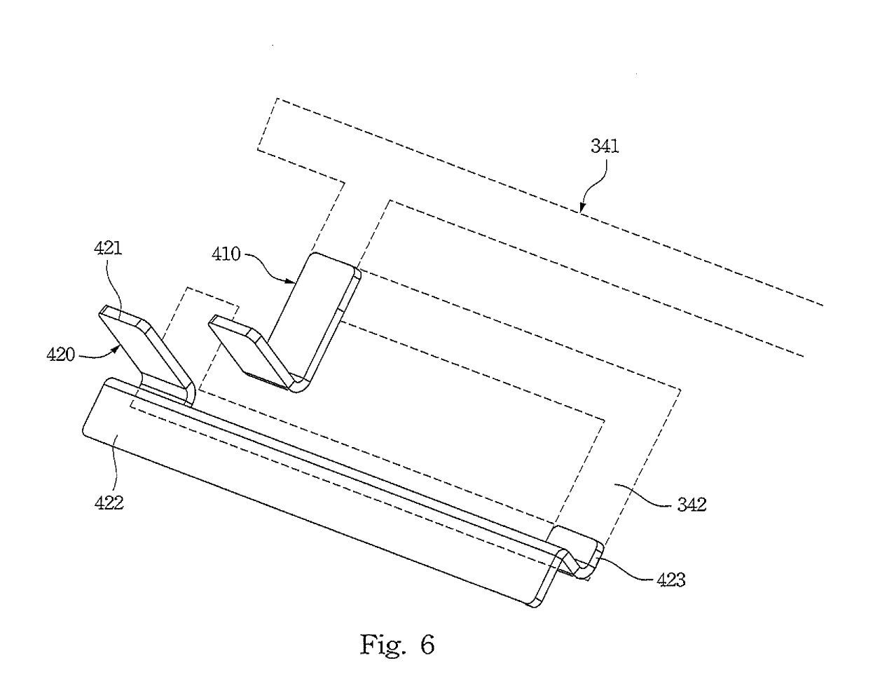

Refer to FIG. 4 to FIG. 6 in which FIG. 4 is a partial schematic view illustrating the first chassis 310 in FIG. 1 observed along a direction D2, FIG. 5 is a sectional view of FIG. 4 along with line 5-5, and FIG. 6 is a schematic view illustrating the position relations of the embedded conductive bodies 400 and the antenna pattern 341 on the first chassis 310.

The portable electrical device 100 further includes a first conductive body 410, a second conductive body 420 and a cable 500. The first conductive body 410 and the second conductive body 420 are respectively embedded inside the case layer 320. Each of the first conductive body 410 and the second conductive body 420 is provided with at least one first end and a second end positioned oppositely with each other. All of the first ends of the first conductive body 410 and the second conductive body 420 are respectively exposed outwards the inner surface 321 of the case layer 320 (see FIG. 4, FIG. 5). All of the second ends of the first conductive body 410 and the second conductive body 420 are respectively exposed outwards the outer surface 322 of the case layer 320 and electrically conducted with the radiator layer 330 (see FIG. 5). The cable 500 is configured on the inner surface 321 of the case layer 320 in which one end of the cable 500 is electrically connected with the first ends of the first conductive body 410 and the second conductive body 420, the other end of the cable 500 is extended to the base unit 200 via the pivot unit P and is electrically connected with the wireless RF module 210 (FIG. 1).

The cable 500 includes a core wire 510 and a reticular conductor layer 520 surrounding the core wire 510 in which the core wire 510 of the cable 500 is defined as a “signal portion”, and the reticular conductor layer 520 of the cable 500 is defined as a “ground portion”.

Specifically, the first conductive body 410 is shaped in the form of “L” in which the first end of the first conductive body 410 is extended to expose outwards the inner surface 321 of the case layer 320, and contacts to electrically conduct the signal portion (i.e. core wire 510) of the cable 500, and the second end of the first conductive body 410 is extended to expose outwards the outer surface 322 of the case layer 320, and contacts to electrically conduct the signal end of the antenna patterns 341. The second conductive body 420 is elongated in shape, and the second conductive body 420 includes a first conducting portion 421, a second conducting portion 422 and a third conducting portion 423. The first conducting portion 421 is disposed on the first end of the second conductive body 420 and is extended to expose outwards the inner surface 321 of the case layer 320, and contacts to electrically conduct the ground portion (i.e. reticular conductor layer 520) of the cable 500. The second conducting portion 422 is disposed on the other first end of the second conductive body 420 and is extended to expose outwards the inner surface 321 of the case layer 320 in which the second conducting portion 422 is shown as a plain surface spreading along a long axle direction of the long lateral sides 311, and the area of the second conducting portion 422 is larger than that of the first conducting portion 421. The second conducting portion 422 electrically conducts with a conductive foil 530, and the second conducting portion 422 is electrically conducted with a ground source G of the portable electrical device 100 via the conductive foil 530. The third conducting portion 423 is disposed on the second end of the second conductive body 420, and is extended to expose outwards the outer surface 322 of the case layer 320, and is electrically conducted with ground end of the antenna patterns 341.

In one embodiment of the invention, the mentioned-above antenna patterns 341 could be positioned on the same lateral side with the first chassis 310, for example, the mentioned-above antenna patterns 341 and the conductive bodies 410, 420 are mutually positioned on one of the long lateral sides 311 far away from the pivot unit P, thus, the cable 500 is extended from the long lateral side 311 thereof into the base unit 200 via one of the short lateral side 312 thereof and the pivot unit P, and electrically conducts the wireless RF module 210. However, the feature that the mentioned-above antenna patterns 341 and the conductive bodies 410, 420 being mutually positioned on one of the long lateral sides 311 far away from the pivot unit P is not limited in the invention, the mentioned-above antenna patterns 341 and the conductive bodies 410, 420 also can be mutually positioned on one of the short lateral sides 311.

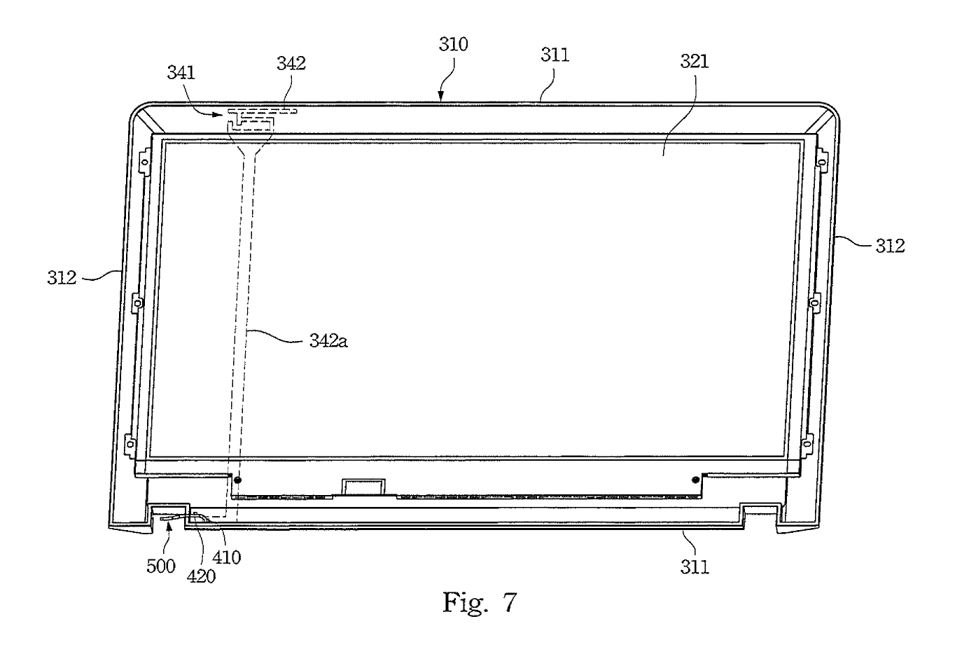

Refer to FIG. 7 in which FIG. 7 is a schematic view illustrating the first chassis of the portable electrical device 100 observed along the direction D2 (FIG. 1) through the second chassis 370 according to another embodiment of the present invention.

In another embodiment of the invention, an extension 342a of the metal wires 342 configured on the outer surface 322 of the case layer 320 can replace a portion of length of the cable 500. Substantially, the antenna pattern 341 spreads from one of the long lateral sides 311 far away from the pivot unit P (FIG. 1) to the other long lateral sides 311 neighboring to the pivot unit P. For this embodiment, the conductive bodies 410, 420 are configured on the other long lateral sides 311 of the case layer 320 neighboring to the pivot unit P, and the second ends of the conductive bodies 410, 420 remain to electrically conduct the signal end and the ground end of the antenna patterns 341, respectively.

Therefore, due to the miniaturization design of the portable electrical device 100, the containing space of the display unit 300 is shrunk. However, since the mentioned above antenna patterns 341 are configured on the outer surface 322 of the first chassis 310, and are made by a printing manner, thus, the antenna patterns 341 do not occupy in the containing space of the display unit 300, and the antenna patterns 341 are thin on the outer surface 322 of the first chassis 310, thus, the antenna patterns 341 can be made approximately according to a profile of the chassis of the display unit 300.

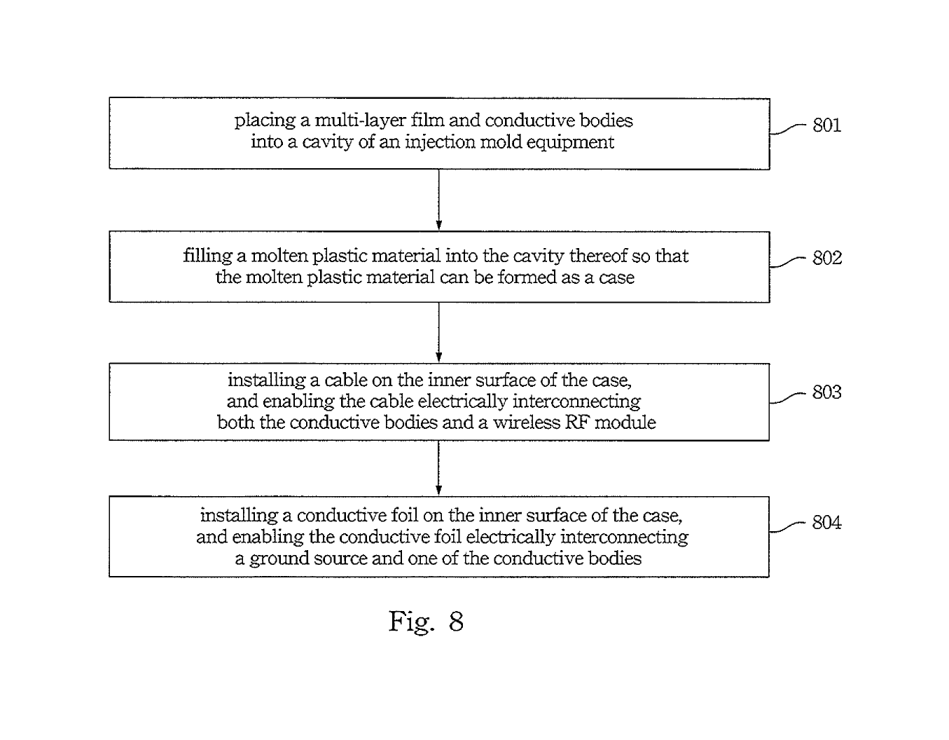

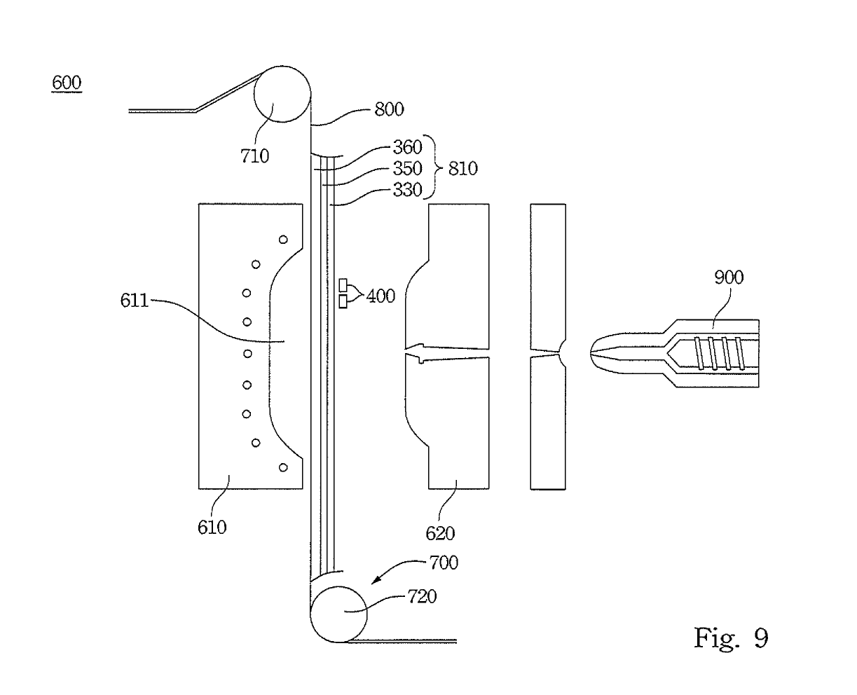

Refer to FIG. 8 and FIG. 9 in which FIG. 8 is a flowchart of a manufacturing method of a portable electrical device 100 according to one embodiment of the present invention, FIG. 9 is an operation schematic view of an injection mold equipment when processing Step 801 in FIG. 8.

The manufacturing method thereof is regarding to an image transfer technology of In-Mold Decoration (IMD) technology, e.g. In-Mold Forming (IMF) or In-Mold Roller (IMR). Thus, the injection mold equipment can be an IMF machine or an IMR machine. The following discloses an example in the IMR technology; however, the invention does no only limit to that.

The manufacturing method of the portable electrical device 100 at least includes steps as follows:

Step (801): placing a multi-layer film 810 and a plurality of conductive bodies 400 into a cavity 611 of an injection mold equipment.

The mentioned injection mold equipment is an IMR machine, at least includes a machine body 600 equipped with a fixing mold 610, a movable mold 620, a film delivering device 700 and a plastic material injection unit 900 in which the movable mold 620 can be moved towards the fixing mold 610 to approach the fixing mold 610 so as to close a cavity 611 of the fixing mold 610, or the movable mold 620 can be moved away from the fixing mold 610.

The film delivering device 700 includes a first roller 710 represented as an output end, and a second roller 720 represented as a collect end. The first roller 710 loads a bundle type of moving film 800 and outputs a continual moving film 800 to the second roller 720. One surface of the moving film 800 facing to the movable mold 620 is attached with a plurality of multi-layer films 810 arranged equal-distantly thereon.

Thus, the moving film 800 with the multi-layer films 810 can be drawn from the first roller 710 towards the second roller 720, and after the multi-layer films 810 are released from the moving film 800, the section of the moving film 800 without the multi-layer films 810 is drawn and collected in the form of a bundle on the second roller 720. The plastic material injection unit 900 is disposed on one side of the movable mold 620 far away from the cavity 611.

Furthermore, refer to FIG. 3 again, the multi-layer films 810 comprises a radiator layer 330, an ink layer 350 and a protective layer 360 stacked together in sequence in which the radiator layer 330 is the one closest to the plastic material injection unit 900.

In the step, the film delivering device 700 is activated at beginning, the film delivering device 700 starts the first roller 710 and the second roller 720 to spin, and the moving film 800 with the multi-layer films 810 can be drawn from the first roller 710 towards the second roller 720.

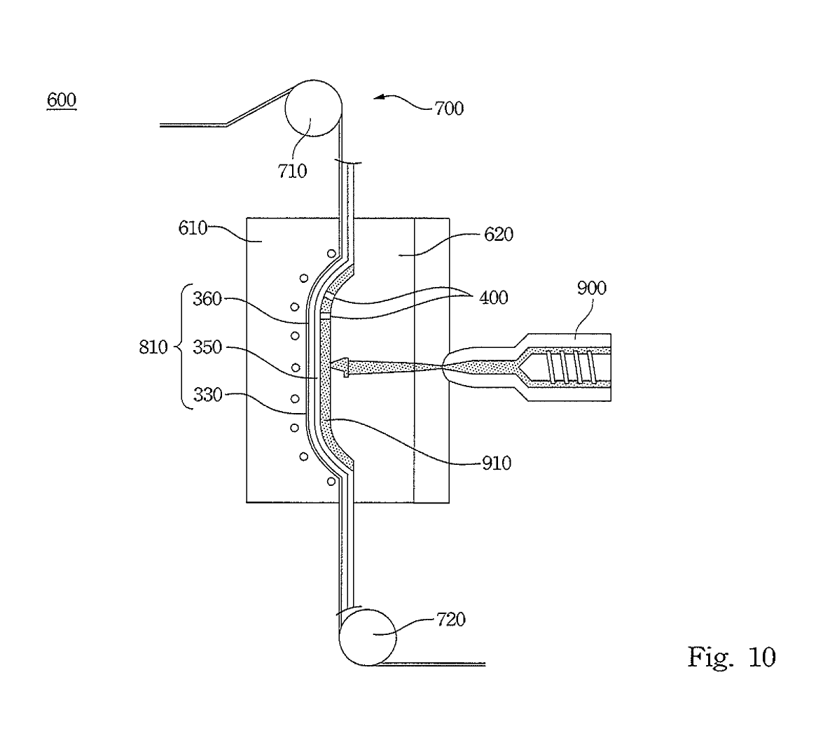

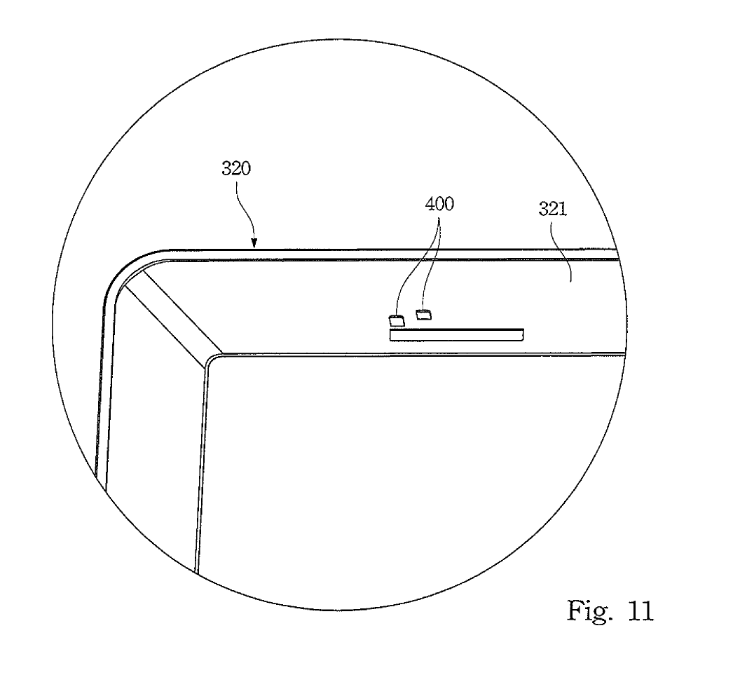

Refer to FIGS. 10 and 11 in which FIG. 10 is an operation schematic view of the injection mold equipment when processing Step 802 in FIG. 8, and FIG. 11 is a partial schematic view of the first chassis when processing Step 802 in FIG. 8.

Step (802): filling a molten plastic material 910 into the cavity 611 thereof so that the molten plastic material 910 can be formed as a case 320.

In this step, there are some specific steps as follows:

Specific step (I): combining the movable mold 620 and the fixing mold 610 to close the cavity 611; next, Specific step (II): activating the plastic material injection unit 900 so as to fill a molten plastic material 910 into the cavity 611 thereof until the molten plastic material 910 is fully filled in the cavity 611 thereof, in which the heat molten plastic material 910 is directly contacted with the radiator layer 330 of the multi-layer films 810; Specific step (III): after the plastic material 910 is cooled to form a case 320, moving the movable mold 620 far away from the fixing mold 620 in which the multi-layer films 810 is attached on the outer surface 322 of the case 320, and the conductive bodies 400 are embedded inside the case 320 in which one end of each conductive body 400 is extended to expose outwards the inner surface 321 of the case 320 (see FIG. 11), and the other end of each conductive body 400 is extended to expose outwards the outer surface 322 of the case 320 (see FIG. 5) and directly contacted the radiator layer 330.

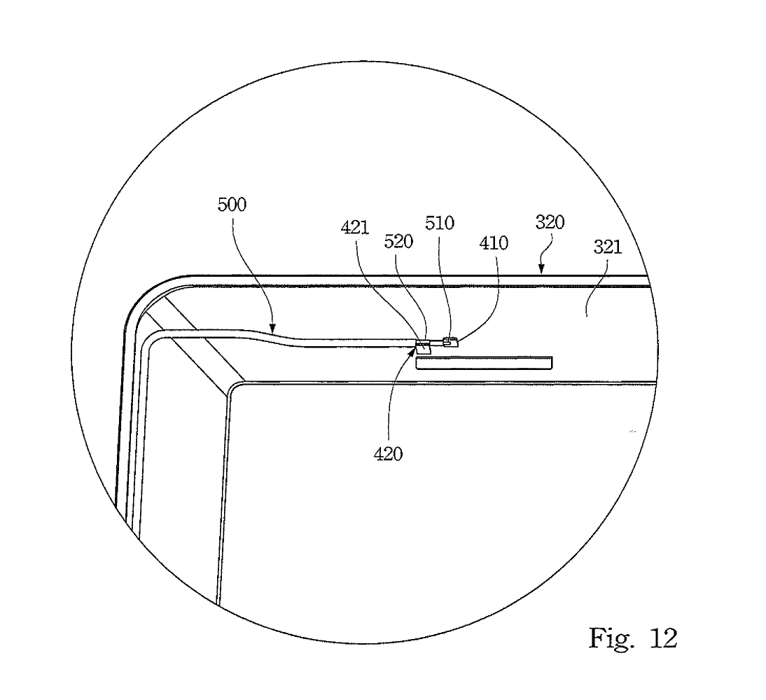

Refer to FIG. 12, in which FIG. 12 is a partial schematic view of the case 320 when processing Step 803 in FIG. 8.

Step (803): installing a cable 500 on the inner surface 321 of the case 320, and enabling the cable 500 electrically interconnecting both the conductive bodies 400 and a wireless RF module 210.

In this step, the signal portion of the cable 500 at one end thereof is soldered on one end of the first conductive body 410, and the ground portion of the cable 500 at the same end thereof is soldered on the first conducting portion 421 of the second conductive body 420.

Step (804): installing a conductive foil 530 on the inner surface 321 of the case 320, and enabling the conductive foil 530 electrically interconnecting a ground source G and the second conductive body 420. (See FIG. 4)

In this step, the conductive foil 530 is attached between the second conducting portion 422 of the second conductive body 420 and the ground source G of the portable electrical device 100, thus, the conductive foil 530 is electrically interconnected the ground source G and the second conductive body 420, so that the conductive foil 530 can lead noise signals from the radiator layer 330 to the ground portion G.

Therefore, by setting a radiator layer on an outer surface of the case, rather than to dispose another lager antenna inside the chassis of the portable electrical device, the manufacturing method of the portable electrical device can save utility room in the chassis. Furthermore, by implementing an insert molding technology in the present invention, the conductive bodies are embedded to penetrate through the chassis, and the conductive bodies can interconnect the radiator layer and the wireless RF module which are positioned oppositely on the chassis so that a complicated wiring process used for interconnecting the radiator layer and the wireless RF module can be eliminated.

The portable electrical device of the present invention is not only limited to a notebook computer, the portable electrical device of the present invention also can be represented as any electric device with a radiator antenna, such as a notebook computer, a tablet computer, a mobile phone, a personal digital Assistant (PDA) [symbol] a GPS device or other portable electric device etc.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A portable electrical device, comprising:
a chassis, comprising:
a case layer provided with an inner surface and an outer surface opposite with each other; and
a radiator layer stacked on the outer surface of the case layer;
a first conductive body and a second conductive body respectively embedded inside the case layer, wherein each of the conductive bodies has at least one first end and a second end opposite with each other, and the at least one first end thereof is exposed outwards the inner surface of the case layer, and the second end thereof is exposed outwards the outer surface of the case layer and electrically conducted with the radiator layer;
a wireless RF module; and
a cable electrically interconnected the first conductive body, the second conductive body and the wireless RF module.

2. The portable electrical device according to claim 1, wherein the cable is disposed on the inner surface of the case layer, and the cable comprises:
a signal portion electrically conducted with the first conductive body; and
a ground portion electrically conducted with the second conductive body.

3. The portable electrical device according to claim 2, wherein the second conductive body comprises:
a first conducting portion and a second conducting portion respectively disposed on two of the at least one first end of the second conductive body, wherein the first conducting portion is electrically conducted with the ground portion of the cable, and the second conducting portion is electrically conducted with a ground source of the portable electrical device; and
a third conducting portion disposed on the second end of the second conductive body, and electrically conducted with the radiator layer.

4. The portable electrical device according to claim 1, wherein the radiator layer comprises:
a thin film layer attached on the outer surface of the case layer; and
at least one antenna pattern being composed by metal wires, disposed between the thin film layer and the case layer, and electrically conducted with the second ends of all of the conductive bodies, wherein the at least one antenna pattern comprises a signal end and a ground end electrically conducted to the first conductive body and the second conductive body, respectively.

5. The portable electrical device according to claim 4, wherein the chassis is provided with a plurality of lateral edges, and the antenna pattern and the first conductive body and the second conductive body are both disposed on the same lateral edge of the chassis.

6. The portable electrical device according to claim 4, wherein the chassis is provided with a plurality of lateral edges, the first conductive body and the second conductive body are disposed on one of the lateral edges of the chassis, the antenna pattern is spread from another of the lateral edges of the chassis to the one of the lateral edges of the chassis.

7. The portable electrical device according to claim 1, wherein the chassis further comprises:
a protective layer covering one side of the radiator layer opposite against the case layer; and
an ink layer covering the side of the radiator layer opposite against the case layer, and sandwiched between the protective layer and the radiator layer.

8. The portable electrical device according to claim 7, wherein the protective layer comprises:
an exterior film layer covering one side of the ink layer opposite against the case layer; and
a hard coated layer covering one side of the ink layer opposite against the case layer, and sandwiched between the exterior film layer and the ink layer.

9. The portable electrical device according to claim 7, wherein the protective layer is a hard coated layer, and the hard coated layer covers on one side of the ink layer opposite against the case layer.

10. A manufacturing method of the portable electrical device, comprising:
placing a multi-layer film and a plurality of conductive bodies into a cavity of an injection mold equipment, wherein the multi-layer film comprises a radiator layer, an ink layer and a protective layer in sequence; and
filling a molten plastic material into the cavity of the injection mold equipment so that the molten plastic material is formed as a case,
wherein the multi-layer film is attached on an outer surface of the case, the conductive bodies are embedded into the case in which one end of each of the conductive bodies is exposed outwards the outer surface of the case and is electrically conducted with the radiator layer, and another end of each of the conductive bodies is exposed outwards an inner surface of the case.

11. The manufacturing method of the portable electrical device according to claim 10, further comprising:
installing a cable on the inner surface of the case, and electrically conducting the cable with a wireless RF module and said another end of each of the conductive bodies.

12. The manufacturing method of the portable electrical device according to claim 11, wherein electrically conducting the cable with said another end of each of the conductive bodies further comprising:
soldering said another end of one of the conductive bodies on one signal portion of the cable; and
soldering said another end of another of the conductive bodies on one ground portion of the cable.

13. The manufacturing method of the portable electrical device according to claim 12, further comprising:
installing a conductive foil on the inner surface of the case, and electrically conducting the conductive foil with said another end of said another of the conductive bodies and a ground portion.

14. The manufacturing method of the portable electrical device according to claim 12, wherein the injection mold equipment is an in-mold forming machine or an in-mold roller machine.
